(19) United States
(12) Patent Application Publication
(10) Pub. No.: US 2024/0388639 A1
(43) Pub. Date: Nov. 21, 2024

(54) USING A PREDETERMINED PROXY FOR INSPECTING REQUESTS IN A MICRO FRONT-END (MFE) ARCHITECTURE

(71) Applicant: International Business Machines Corporation, Armonk, NY (US)

(72) Inventors: Matthew Paul Chapman, Eastleigh (GB); Vlad Balanescu, Southampton (GB); Matthew James Clarke, Newbury (GB); Thomas Li, Winchester (GB)

(21) Appl. No.: 18/198,648

(22) Filed: May 17, 2023

(51) Int. Cl. H04L 67/51; H04L 9/40; H04L 67/562

(52) U.S. Cl. CPC H04L 67/51; H04L 63/1433; H04L 67/562

(57) ABSTRACT

A computer-implemented method, according to one embodiment, includes identifying a first request, from a first client device to a first micro-front-end (MFE) service of a MFE architecture, for loading a first child component associated with the first MFE service. The method further includes causing the first request for loading the first child component to be inspected by a predetermined proxy before being potentially fulfilled. The predetermined proxy is configured to inspect content and/or behavior of other MFE services of the architecture. A determination is made, based on results of the inspection of the first request by the predetermined proxy, whether fulfillment of the first request violates predetermined compatibility conditions associated with the other MFE services. In response to a determination that fulfillment of the first request violates at least a predetermined portion of the predetermined compatibility conditions, a predetermined mitigating operation is performed for mitigating performance losses in the architecture.

### BACKGROUND

The present invention relates to micro front-end (MFE) architectures, and more specifically, this invention relates to using a predetermined proxy for inspecting requests in a micro front-end (MFE) architecture.

A microservice architecture is an architecture that includes a plurality of microservices. The microservices are generally single function modules that communicate and work with each other to perform some greater function. This architecture is becoming more popular because of the advantages it offers such as the option to quickly update code, to easily scale microservices, and to enable independent development.

### SUMMARY

A computer-implemented method, according to one embodiment, includes identifying a first request, from a first client device to a first micro-front-end (MFE) service of a MFE architecture, for loading a first child component associated with the first MFE service. The method further includes causing the first request for loading the first child component to be inspected by a predetermined proxy before being potentially fulfilled. The predetermined proxy is configured to inspect content and/or behavior of other MFE services of the MFE architecture. A determination is made, based on results of the inspection of the first request by the predetermined proxy, whether fulfillment of the first request violates predetermined compatibility conditions associated with the other MFE services. In response to a determination that fulfillment of the first request violates at least a predetermined portion of the predetermined compatibility conditions, a predetermined mitigating operation is performed for mitigating performance losses in the MFE architecture.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a micro front-end (MFE) architecture, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using a predetermined proxy for inspecting requests in a micro front-end (MFE) architecture.

In one general embodiment, a computer-implemented method includes identifying a first request, from a first client device to a first micro-front-end (MFE) service of a MFE architecture, for loading a first child component associated with the first MFE service. The method further includes causing the first request for loading the first child component to be inspected by a predetermined proxy before being potentially fulfilled. The predetermined proxy is configured to inspect content and/or behavior of other MFE services of the MFE architecture. A determination is made, based on results of the inspection of the first request by the predetermined proxy, whether fulfillment of the first request violates predetermined compatibility conditions associated with the other MFE services. In response to a determination that fulfillment of the first request violates at least a predetermined portion of the predetermined compatibility conditions, a predetermined mitigating operation is performed for mitigating performance losses in the MFE architecture.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as proxy component code of block 150 for using a predetermined proxy for inspecting requests in a micro front-end (MFE) architecture. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

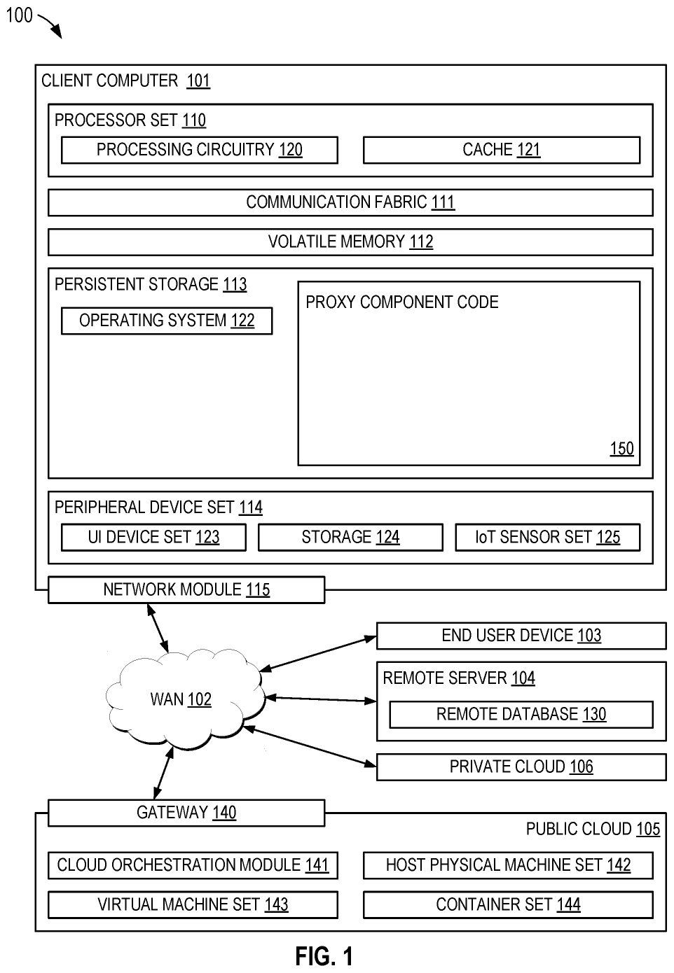

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, a microservice architecture is an architecture that includes a plurality of microservices. The microservices are generally single function modules that communicate and work with each other to perform some greater function. This architecture is becoming more popular because of the advantages it offers such as the option to quickly update code, to easily scale microservices, and to enable independent development.

Some front-ends developments include separating relatively large web applications into relatively smaller independent parts, where each individual component has an associated realm. This is analogous to a microservices architecture and is known as a micro front-end (MFE) architecture. Where such implementations are chosen over classic implementations, several development teams can be employed to have ownership of one or more microservices. This is beneficial in the sense that each of such teams are thereby able to deliver code on their own timeline, independent of the rest of the microservices. Traditional techniques of bundling up microservices into one single parent application has always involved a dependency build manager, such as in the JAVASCRIPT community, WEBPACK. At build time, this dependency build manager is able to bundle up and transpile all of the parent's application code into browser understandable JAVASCRIPT, e.g., ES6 converted to ES5, but also break the code down into several chunks. This code breakdown relatively enhances client-side performance and provides a relatively fast and reliable load time on the user side.

Until recently, there have been relatively few techniques for composing relatively large applications at run time rather than build time. The MFEs concept has been introduced, and as a result, instead of bundling everything at build time into one or more chunks to serve the code to the client, each MFE is bundled up separately. This allows for relatively more flexibility, as a single MFE can be rebuilt and redeployed in isolation, without needing to rebuild and redeploy the entire application. The WEBPACK tool as of version 5 provides capabilities for bundling separate MFEs, and also provides additional capabilities such as allowing MFEs to share specified packages to reduce duplication.

This runtime composition provides some benefits over build-time composition, but also introduces new problems. For example, development teams are often unaware whether dependencies will introduce any security vulnerabilities straight into their parent application. In another example, a parent applications' development team may be unable to trust that no two child dependencies will rely on different versions of a third dependency, which would otherwise impact performance of the parent application and thereby also impact the user experience. These and other problems arise with regards to the new MFE concept.

The techniques of embodiments and approaches described herein mitigate these problems. Specifically, these techniques implement and use a predetermined component that acts as a proxy and/or gatekeeper between a host frontend and services in an MFE architecture. The predetermined component that is caused, e.g., instructed, to check what is being loaded by each MFE of the MFE architecture to ensure that there will not be any negative impact on the parent app and/or component's behavior and the user experience. This predetermined component preferably is caused to perform several checks on every child component being loaded. For example, the predetermined component may, in some approaches, be implemented as a front-end application that is composed at runtime from multiple independent components, e.g., MFEs, with the additional capabilities of being able to analyze requests made to each MFE and the responses from them, and perform additional actions based on that analysis, such as alerting, blocking out requests or report generation. As will be described in greater detail elsewhere herein, these analyzing checks may include, e.g., checking for any outdated dependencies or security vulnerabilities present in the child component, reporting any vulnerabilities found for further investigation, potentially blocking such requests for critical vulnerabilities, running contract tests to ensure that no broken integration points exist between different MFEs, checking for duplication of packages across MFEs to identity candidates for sharing, other methods of analysis to help optimize the parent application's user experience, etc. The value that implementing these techniques offers includes improving an integrity of the overall MFE system, as security issues are more readily identified. Furthermore, these techniques ensure that no breaking updates are introduced into the application, and furthermore enable relatively increased sharing which may lead to relatively more optimized bundles and thereby relatively reduced load times.

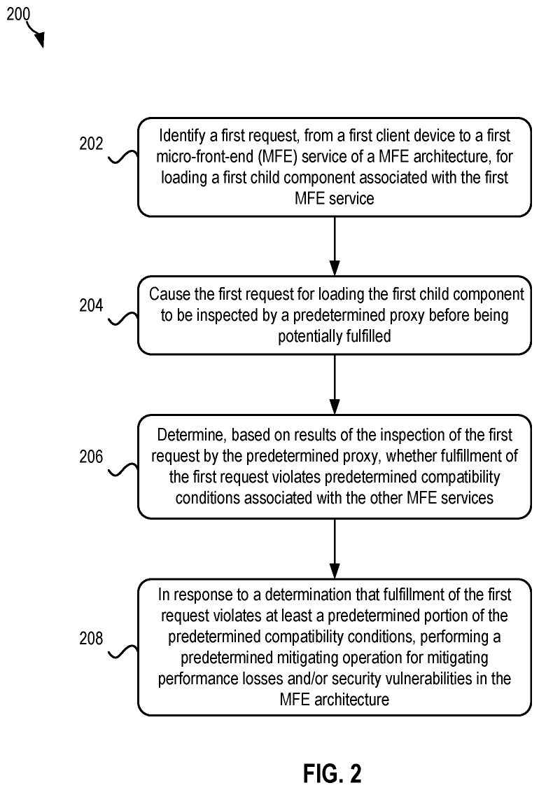

Now referring to FIG. 2, a flowchart of a method 200 is shown according to one embodiment. The method 200 may be performed in accordance with the present invention in any of the environments depicted in FIGS. 1-3, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 200 may, in some preferred approaches, be performed in a MFE architecture. The MFE architecture may be based on a web application that includes a host and/or parent frontend. The frontend may be configured to control a user interface associated with the web application. In some approaches, the frontend delegates the rendering of a predetermined portion of components to MFE services of the frontend. For example, the frontend may include a plurality of MFE services, e.g., a first MFE service, a second MFE service, a third MFE service, etc., that are each associated with at least one unique child component, e.g., chunk, of the web application of the frontend. For example, in some approaches, the first MFE service may be configured to, in response to receiving a request for loading a first child component, selectively load the first child component. For context, a “child component” may be of a type that would become apparent to one of ordinary skill in the art after reading the descriptions herein, e.g., a page of the application, a feature of the web application, a portion of a page of the web application, a search bar of the web application, etc. However, in some preferred approaches, the MFE services are not allowed to simply load the components in response to receiving a request to do so. Instead, as will be described in greater detail below, techniques described herein may rely on an intermediate component, e.g., referred to below as a “predetermined proxy”, that is inserted between the host frontend and the individual MFE services, that is used to determine whether loading a requested child component violates at least a predetermined portion of predetermined compatibility conditions. By ensuring that the predetermined portion of the predetermined compatibility conditions are not violated, performance issues, that would otherwise be experienced within the MFE environment as a result of incompatibility issues occurring as a result of loading a child component, are avoided. This results in relatively improved performance in the MFE environment.

Operation 202 includes identifying a first request, from a first client device to a first micro-front-end (MFE) service of a MFE architecture, for loading a first child component associated with the first MFE service. In some approaches, the first request is identified based on the first request being processed by a queue. For example, the MFE architecture may include a queue that all requests from client devices are directed to. In some approaches, the queue may be a component of a predetermined proxy that is configured to process such requests, e.g., see operation 204 elsewhere below.

In some approaches, the first child component may be code that is loaded by the first MFE service to provide the requesting client device with an associated feature of the web application, e.g., a first page of the web application. In some approaches, the code that is loaded by the first MFE service to provide the requesting client device with the associated feature of the web application is an independent portion of child code. In other words, rather than an entire bundle of a plurality of child codes being loaded to offer the first client device the requested feature of the web application, the first MFE service is relied on to selectively provide the independent portion of child code used to deliver the first page of the web application.

The first request may, in some approaches, additionally and/or alternatively be identified on a back-end server of the MFE architecture. In one or more of such approaches, the first request is identified using an application programming interface (API) gateway. In contrast, in some other approaches, the first request may be identified on a client-side of the MFE architecture. For example, in one of such approaches, the first request is identified in a browser on the client-side of the MFE architecture. However, it should be noted that, in some approaches, the server only sees a request for a file, e.g., a JavaScript file. One advantage of the client-side approach is that there is relatively more context available. For example, it is known and/or may be determined which component has been requested, as well as the chunk it is in. This allows for relatively more selectivity in the actions taken, e.g., for example based on a nature and severity of the vulnerability detected. In some approaches, these actions include, raising an alert to an engineering team, disabling only the component requested, disabling the full chunk, disabling the entire MFE, etc.

Operation 204 includes causing, e.g., instructing the predetermined proxy, the first request for loading the first child component to be inspected by a predetermined proxy before being potentially fulfilled. The predetermined proxy is, in some approaches, a general bundler plugin. For example, in some approaches, the bundler plugin may be configured to supplement MFE capabilities by being added as code to bundles generated in the MFE architecture.

In some preferred approaches, the predetermined proxy is configured to inspect content and/or behavior of other MFE services of the MFE architecture to determine whether to fulfill the first request. In at least some of such approaches, this inspection of content and/or behavior of other MFE services of the MFE architecture includes generating results of the inspection of the first request. For example, in some approaches, predetermined metrics associated with each of the MFE services may be determined and incorporated into a results table and/or compared with one another. In some approaches, these predetermined metrics include, e.g., security measures that the MFE service currently deploys, information that details versions of code that the MFE service currently runs, dependencies that an MFE service has with other MFE services, contracts that an MFE service has with other MFE services, a use history of MFE services, etc. In some other approaches, these predetermined metrics may be incorporated into a dependency tree that is generated based on dependencies that are determined during the inspection. In some approaches, these predetermined metrics are obtained from a log file where information associated with the MFE services is logged in.

For context, the predetermined proxy inspects the content and behavior of the child components and the MFE services in order to be able to raise alerts and/or take appropriate actions against any concerns raised during the analysis of aforementioned MFE services. Various analysis techniques that may be performed in addition to and/or alternative to the inspection operations described above are detailed below.

In some preferred approaches, the inspection considers a security impact within the MFE environment of loading the first child component to fulfill the first request. In some approaches, the inspection is performed on responses that are output by the MFE component to which the request is directed, e.g., the first MFE service. During the security impact inspection, an analysis may be performed to determine what is being loaded and trigger external actions, e.g., alerts to developers, based on a variety of indicators such as the presence and severity of known vulnerabilities and bugs. In some other approaches, the inspection may additionally and/or alternatively consider a performance impact within the MFE environment of loading the first child component to fulfill the first request. During the performance impact inspection, in some approaches, the performance, e.g., load time, of the host frontend and the impact of any child components being loaded may be determined. In some optional approaches, any MFE services that are determined to be highly detrimental to the overall performance of the application may be flagged, e.g., MFE services that are determined to be capable of causing at least a predetermined degree of incompatibility with other MFE services in the event that the first child component was to be loaded. In some approaches, the performance impact inspection may be performed once during and/or subsequent to the first child component being loaded, e.g., an initial load.

The inspection may additionally and/or alternatively include performing contract tests of a type that would become apparent to one of ordinary skill in the art after reading the descriptions herein. In some approaches, any dependencies that have broken contract tests with a parent MFE service may be flagged. Such an inspection may, in some approaches, be performed once on loading of the child component.

Dependency tree shaking may additionally and/or alternatively be performed during the inspection, in some approaches. For example, in some approaches, the dependency tree shaking may include detection and alerting of duplicate dependencies within the dependency tree, and may optionally be performed once on loading of the child component.

In some other approaches, the inspection may be performed to determine whether code conflicts will result as a result of the first child component being loaded. For example, the inspection may search and compare parameters of the MFE services to determine whether conflicting stylesheet rules or overloaded method definitions exist. In some approaches, this inspection may optionally be performed once on loading of the child component. The inspection may, in some approaches, additionally and/or alternatively include scanning for unused/stale MFE services in the MFE environment, e.g., individual entry points, or any other type of inspection that would become apparent to one of ordinary skill in the art after reading the descriptions herein.

It should be noted that, in some preferred approaches, the MFE services and/or functionality of the MFE environment are not compromised during the inspection being performed. Instead, in some preferred approaches, testing trials and/or hypothetical test trials of a type that would become apparent to one of ordinary skill in the art after reading the descriptions herein may instead be run to perform such inspections. In some other approaches, the inspections may be performed during and/or subsequent to child component being loaded, and based on results of the inspection, rules pertaining to which child component load requests are allowed and which child component load requests are blocked by the predetermined proxy may be dynamically adjusted based on an associated performance of the MFE.

Operation 206 includes determining, based on results of the inspection of the first request by the predetermined proxy, whether fulfillment of the first request violates predetermined compatibility conditions associated with the other MFE services. For context, the predetermined compatibility conditions are, in some preferred approaches, metrics and/or rules that are used to determine whether loading a requested child component will incorporate a predetermined unacceptable amount of compatibility issues into the functioning of the web application. Furthermore, the predetermined compatibility conditions are preferably based on the inspection performed, e.g., see operation 204. This way, the results of the inspection may be evaluated to determine whether, from a performance standpoint, the request should be fulfilled, e.g., the requested child component should be loaded. For example, in some approaches, a first of the predetermined compatibility conditions is based on a security impact of loading the first child component.

In some other approaches, the predetermined compatibility condition may be based on, e.g., a performance impact condition, a contract test condition, a dependency tree shaking condition, and a code conflict condition, etc. In one or more of such approaches, the determination of whether fulfillment of the first request violates the predetermined compatibility conditions associated with the other MFE services may be performed once upon the first child component being loaded.

In some approaches, the results of the inspection may include a plurality of compatibility scoring values, e.g., within a predetermined compatibility range. One or more techniques for determining a compatibility scoring of a predetermined range that would become apparent to one of ordinary skill in the art after reading the descriptions herein may be used. Note that, in some approaches, a different predetermined compatibility range may be used for each type of inspection performed, and furthermore, a compatibility scoring value may be determined for each of the types of inspection performed.

In some approaches, for a given one of the predetermined compatibility conditions, an associated compatibility scoring value may be compared with a predetermined threshold. In response to a determination that the compatibility scoring value exceeds the predetermined threshold, a determination is made that loading the first child component will not cause the associated predetermined compatibility condition to be violated. In contrast, in response to a determination that the compatibility scoring value does not exceed the predetermined threshold, a determination is made that loading the first child component will cause the associated predetermined compatibility condition to be violated.

In response to a determination that fulfillment of the first request violates at least a predetermined portion of the predetermined compatibility conditions, e.g., half of the predetermined compatibility conditions, a majority of the predetermined compatibility conditions, all of the predetermined compatibility conditions, method 200 preferably includes performing a predetermined mitigating operation for mitigating performance losses in the MFE architecture. In some approaches, the predetermined mitigating operation includes generating and outputting an alert that details the performance losses that can be expected from fulfilling the first request. In another approach, the predetermined mitigating operation may additionally and/or alternatively include blocking the first request, e.g., not fulfilling the request and/or blocking future requests that match the first request for a predetermined amount of time and/or until an update is performed to mitigate the violation of the at least a predetermined portion of the predetermined compatibility conditions. In yet another approach, the predetermined mitigating operation may additionally and/or alternatively include generating and outputting a report that details the violation of at least the predetermined portion of the predetermined compatibility conditions, e.g., to the first client device, to a development operations team, to a device used by an engineering team that is authorized to initiate updates to the MFE services, etc. In another approach, in response to a determination that the requested child component has any type of security vulnerability, e.g., as indicated by the determination that one or more of the predetermined compatibility conditions are violated, a loading of the whole child component may be failed, and an alert may be output. In some approaches, the failed loading may be based on the error boundary of the host application.

It should be noted that, although various approaches described above, are described from the operational perspective of the first request for the first MFE service, method 200 may optionally, additionally and/or alternatively include operations performed with respect to a second request for a second MFE service of the MFE architecture. For example, in some approaches, a second request, from a second client device to a second MFE service of the MFE architecture, for loading a second child component associated with the second MFE service may be identified. Note that, in preferred approaches, the second child component and the second MFE service are different than the first child component and the first MFE service. The second request may be caused to be inspected by the predetermined proxy before being potentially fulfilled. A determination may be made, based on results of the inspection of the second request by the predetermined proxy, as to whether fulfillment of the second request violates predetermined compatibility conditions associated with the other MFE services. In response to a determination that fulfillment of the second request violates at least the predetermined portion of the predetermined compatibility conditions, one or more of the predetermined mitigating operations described elsewhere above, e.g., see operation 208, may be performed with respect to the second request for mitigating performance losses and/or security vulnerabilities in the MFE architecture.

In some approaches, any one or more of the operations described above may be selectively performed on a predetermined runtime schedule. For example, in some approaches, the first request is identified during a first runtime schedule and/or the second request is identified during a second runtime schedule. In some of such approaches, first operations are performed during the first runtime schedule. The first operations may, in some approaches, include checking for new vulnerabilities publicly disclosed on a predetermined specialist website, gathering common vulnerabilities and exposures (CVEs) in response to a determination that child components have been loaded in the MFE architecture, and scanning the child components for potentially identifying requests that violate the CVEs. In some approaches, second operations are performed during the second runtime schedule. For example, the second operations may, in some approaches, include checking for new child component updates (performed since a last check), and in response to a determination that at least one of the child components has been updated, scanning the updated child components. In some approaches, in response to a determination that a given child component has not been updated, the proxy component preferably does not scan the child component and/or associated MFE service.

Various benefits that preserve and relatively increase performance within the MFE architecture are enabled as a result of the techniques described herein. For example, compared to the deficiencies of the conventional techniques described elsewhere herein, these novel techniques, e.g., the operations of method 200, provide a distinction between various sub-components of a main host user interface that is relatively clearer. Furthermore, these novel techniques allow for an entire MFE and/or a child component thereof to be shut down in response to a determination that a security vulnerability is identified. Accordingly, a relatively clear boundary is established between subcomponents of the host user interface. Furthermore, security vulnerabilities are able to be identified and avoided as a result of the techniques described herein. As a result, failure events that would otherwise be experienced by client devices are also avoided. These failure events would otherwise result in a compromised application interface and/or experience for users. Recovery from such events often involves extensive debugging and processing of the microservices of the applications in order to restore the compromised application. Accordingly, the techniques described herein enable processing resources to be preserved as a result of such failure events being avoided. Additional benefits of the techniques described herein are based on the fact that an application is enabled to respond to a disclosed vulnerability without an engineering team having to develop a code change and redeploy the application. This leads to significant savings and maintained throughput. Furthermore, it should be noted that, because developers do not need to spend time actually fixing identified security vulnerabilities, these developers are free to focus on delivering relatively high quality production-ready code.

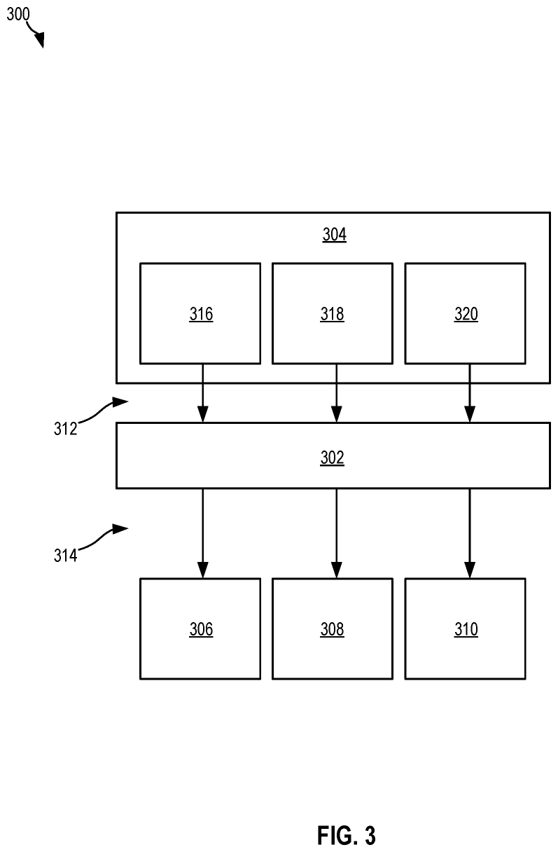

FIG. 3 depicts an MFE architecture 300, in accordance with one embodiment. As an option, the present MFE architecture 300 may be implemented in conjunction with features from any other embodiment listed herein, such as those described with reference to the other FIGS. Of course, however, such MFE architecture 300 and others presented herein may be used in various applications and/or in permutations which may or may not be specifically described in the illustrative embodiments listed herein. Further, the MFE architecture 300 presented herein may be used in any desired environment.

The MFE architecture 300 includes an intermediate component 302, e.g., a predetermined proxy component, that is inserted between the host frontend 304 and the individual MFE services 306, 308 and 310. This way, whenever a request is made to load a child component that is exposed by an MFE service, the request and response are caused to pass through the intermediate component, e.g., see operations 312 and 314.

In some approaches, the intermediate component may be caused to then perform additional actions based on the analysis of those requests and responses, as the intermediate component is configured to have a view across all of the MFEs in the MFE architecture. In one example embodiment, the intermediate component may be implemented as a general plugin, which may be used to supplement MFE capabilities by adding code to generated bundles to implement operations described above, e.g., see method 200.

It should be noted that MFE services 316, 318 and 320 are the MFE services 306, 308, 310, but are shown in the host frontend 304 to depict that requests for loading child components of the services are not fulfilled until potentially after the intermediate component performs the inspection operations described elsewhere herein.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying a first request, from a first client device to a first micro-front-end (MFE) service of a MFE architecture, for loading a first child component associated with the first MFE service;
causing the first request for loading the first child component to be inspected by a predetermined proxy before being potentially fulfilled, wherein the predetermined proxy is configured to inspect content and/or behavior of other MFE services of the MFE architecture;
determining, based on results of the inspection of the first request by the predetermined proxy, whether fulfillment of the first request violates predetermined compatibility conditions associated with the other MFE services; and
in response to a determination that fulfillment of the first request violates at least a predetermined portion of the predetermined compatibility conditions, performing a predetermined mitigating operation for mitigating performance losses in the MFE architecture.

2. The computer-implemented method of claim 1, wherein the predetermined mitigating operation is selected from the group consisting of: generating and outputting an alert, blocking the first request, and generating and outputting a report that details the violation of at least the predetermined portion of the predetermined compatibility conditions to the first client device.

3. The computer-implemented method of claim 1, wherein a first of the predetermined compatibility conditions is based on a security impact of loading the first child component.

4. The computer-implemented method of claim 1, wherein a first of the predetermined compatibility conditions is selected from the group consisting of: a performance impact condition, a contract test condition, a dependency tree shaking condition, and a code conflict condition, wherein the determination of whether fulfillment of the first request violates the predetermined compatibility conditions associated with the other MFE services is performed once upon the first child component being loaded.

5. The computer-implemented method of claim 1, wherein the predetermined proxy is a bundler plugin, wherein the bundler plugin supplements MFE capabilities by being added as code to bundles generated in the MFE architecture.

6. The computer-implemented method of claim 1, comprising:
identifying a second request, from a second client device to a second MFE service of the MFE architecture, for loading a second child component associated with the second MFE service, wherein the second child component and the second MFE service are different than the first child component and the first MFE service;
causing the second request to be inspected by the predetermined proxy before being potentially fulfilled;
determining, based on results of the inspection of the second request by the predetermined proxy, whether fulfillment of the second request violates predetermined compatibility conditions associated with the other MFE services; and
in response to a determination that fulfillment of the second request violates at least the predetermined portion of the predetermined compatibility conditions, performing the predetermined mitigating operation for mitigating performance losses in the MFE architecture.

7. The computer-implemented method of claim 6, wherein the first request is identified during a first runtime schedule, wherein the second request is identified during a second runtime schedule, wherein first operations are performed during the first runtime schedule, wherein the first operations include: checking for new vulnerabilities publicly disclosed on a predetermined specialist website, gathering common vulnerabilities and exposures (CVEs) in response to a determination that child components have been loaded in the MFE architecture, and scanning the child components for potentially identifying requests that violate the CVEs, wherein second operations are performed during the second runtime schedule, wherein the second operations include: checking for child component updates, and in response to a determination that at least one of the child components has been updated, scanning the at least one updated child component.

8. The computer-implemented method of claim 1, wherein the first request is identified on a back-end server of the MFE architecture, wherein the first request is identified using an application programming interface (API) gateway.

9. The computer-implemented method of claim 1, wherein the first request is identified on a client-side of the MFE architecture, wherein the first request is identified in a browser.

10. A computer program product, the computer program product comprising a computer readable storage medium having program instructions embodied therewith, the program instructions readable and/or executable by a computer to cause the computer to:
identify a first request, from a first client device to a first micro-front-end (MFE) service of a MFE architecture, for loading a first child component associated with the first MFE service;
cause the first request for loading the first child component to be inspected by a predetermined proxy before being potentially fulfilled, wherein the predetermined proxy is configured to inspect content and/or behavior of other MFE services of the MFE architecture;
determine, based on results of the inspection of the first request by the predetermined proxy, whether fulfillment of the first request violates predetermined compatibility conditions associated with the other MFE services; and
in response to a determination that fulfillment of the first request violates at least a predetermined portion of the predetermined compatibility conditions, perform a predetermined mitigating operation for mitigating performance losses in the MFE architecture.

11. The computer program product of claim 10, wherein the predetermined mitigating operation is selected from the group consisting of: generating and outputting an alert, blocking the first request, and generating and outputting a report that details the violation of at least the predetermined portion of the predetermined compatibility conditions to the first client device.

12. The computer program product of claim 10, wherein a first of the predetermined compatibility conditions is based on a security impact of loading the first child component.

13. The computer program product of claim 10, wherein a first of the predetermined compatibility conditions is selected from the group consisting of: a performance impact condition, a contract test condition, a dependency tree shaking condition, and a code conflict condition, wherein the determination of whether fulfillment of the first request violates the predetermined compatibility conditions associated with the other MFE services is performed once upon the first child component being loaded.

14. The computer program product of claim 10, wherein the predetermined proxy is a bundler plugin, wherein the bundler plugin supplements MFE capabilities by being added as code to bundles generated in the MFE architecture.

15. The computer program product of claim 10, the program instructions readable and/or executable by the computer to cause the computer to:
identify a second request, from a second client device to a second MFE service of the MFE architecture, for loading a second child component associated with the second MFE service, wherein the second child component and the second MFE service are different than the first child component and the first MFE service;
cause the second request to be inspected by the predetermined proxy before being potentially fulfilled;
determine, based on results of the inspection of the second request by the predetermined proxy, whether fulfillment of the second request violates predetermined compatibility conditions associated with the other MFE services; and
in response to a determination that fulfillment of the second request violates at least the predetermined portion of the predetermined compatibility conditions, perform the predetermined mitigating operation for mitigating performance losses in the MFE architecture.

16. The computer program product of claim 15, wherein the first request is identified during a first runtime schedule, wherein the second request is identified during a second runtime schedule, wherein first operations are performed during the first runtime schedule, wherein the first operations include: checking for new vulnerabilities publicly disclosed on a predetermined specialist website, gathering common vulnerabilities and exposures (CVEs) in response to a determination that child components have been loaded in the MFE architecture, and scanning the child components for potentially identifying requests that violate the CVEs, wherein second operations are performed during the second runtime schedule, wherein the second operations include: checking for child component updates, and in response to a determination that at least one of the child components has been updated, scanning the at least one updated child component.

17. The computer program product of claim 10, wherein the first request is identified on a back-end server of the MFE architecture, wherein the first request is identified using an application programming interface (API) gateway.

18. The computer program product of claim 10, wherein the first request is identified on a client-side of the MFE architecture, wherein the first request is identified in a browser.

19. A system, comprising:
a processor; and
logic integrated with the processor, executable by the processor, or integrated with and executable by the processor, the logic being configured to:
identify a first request, from a first client device to a first micro-front-end (MFE) service of a MFE architecture, for loading a first child component associated with the first MFE service;
cause the first request for loading the first child component to be inspected by a predetermined proxy before being potentially fulfilled, wherein the predetermined proxy is configured to inspect content and/or behavior of other MFE services of the MFE architecture;
determine, based on results of the inspection of the first request by the predetermined proxy, whether fulfillment of the first request violates predetermined compatibility conditions associated with the other MFE services; and
in response to a determination that fulfillment of the first request violates at least a predetermined portion of the predetermined compatibility conditions, perform a predetermined mitigating operation for mitigating performance losses in the MFE architecture.

20. The system of claim 19, wherein the predetermined mitigating operation is selected from the group consisting of: generating and outputting an alert, blocking the first request, and generating and outputting a report that details the violation of at least the predetermined portion of the predetermined compatibility conditions to the first client device.
